(19) United States
(12) Patent Application Publication
(10) Pub. No.: US 2025/0105635 A1
(43) Pub. Date: Mar. 27, 2025

(54) ACTIVE EQUALIZATION METHOD, SYSTEM, AND COMPUTER-READABLE STORAGE MEDIUM

(71) Applicant: Shenzhen CLOU Electronics CO., LTD., Shenzhen (CN)

(72) Inventor: Bai ZHANG, Shenzhen (CN)

(73) Assignee: Shenzhen CLOU Electronics CO., LTD., Shenzhen (CN)

(21) Appl. No.: 18/634,514

(22) Filed: Apr. 12, 2024

(30) Foreign Application Priority Data
Sep. 25, 2023 (CN) 202311248454.6

(51) Int. Cl. H02J 7/00; H01M 10/44; H01M 10/46

(52) U.S. Cl. CPC H02J 7/0014; H01M 10/441; H01M 10/46; H02J 7/0048; H02J 7/007182

(57) ABSTRACT

Disclosed are an active equalization method, a system and a computer-readable storage medium. The active equalization method includes: obtaining a battery cell set to be balanced in the battery cluster; determining whether a battery cell to be balanced in the battery cell set to be balanced contains a charging battery cell; in response to that the charging battery cell is contained, adding one charging battery cell to a preset starting queue; determining whether the battery cell to be balanced in the battery cell set to be balanced contains a discharging battery cell; in response to that the discharging battery cell is contained, adding one discharging battery cell to the starting queue.

### CROSS-REFERENCE TO RELATED APPLICATION

The present application claims priority to Chinese Patent Applications No. 202311248454.6, filed on Sep. 25, 2023, the entire contents of which are incorporated herein by reference for all purposes.

### FIELD

The present application relates to the field of battery control, and in particular to an active equalization method, a system, and a computer-readable storage medium.

### BACKGROUND

The battery management system (BMS) is a real-time monitoring system composed of electronic circuit devices, and can effectively monitor battery voltage, battery current, battery cluster insulation state, battery SOC, battery module and cell state (voltage, current, temperature, SOC, etc.). The BMS includes a battery module management unit (BMU), a battery cluster management system (BCMS) and a battery array management system (BAMS); the BMU is responsible for collecting and managing voltage, current and temperature information of the single battery cell and uploading the information to the BCMS, managing single batteries in the module, and realizing a balancing function of the single battery; the BCMS is responsible for collecting information such as voltage, current, temperature, etc. of the battery modules in the cluster, packaging and uploading the information to the BAMS, managing the battery modules in the cluster, and realizing the balancing function in the cluster; the BAMS is responsible for collecting information such as voltage, current, temperature, etc. of all cells in the battery cluster in the array, analyzing the data, making control and protection strategies and external communication, and managing all the cells in the array.

In order to ensure that the battery is effectively fully charged, it is particularly important that the maximum available capacity of the battery is increased, the service life of the battery is prolonged, and the battery cells in the battery cluster is balanced. In the current cell balancing method, when balancing is performed, all cells to be balanced are usually determined first, and then all the cells to be balanced are started to be balanced at the same time. Because time delay exists between BCMS and BMU communication and starting time of a balancing circuit is not completely the same, voltage of the auxiliary power supply is caused to fluctuate, so that interference is formed in the battery balancing process, and stable performance of battery balancing is not facilitated. Therefore, how to improve the stability of battery equalization becomes a technical problem to be solved.

### SUMMARY

The present application aims to solve at least one of the technical problems existing in the related art. Therefore, the present application provides an active equalization method, a system and a storage medium, which can improve the stability of battery equalization.

An active equalization method according to an embodiment of the first aspect of the present application is applied to an active equalization system, and the active equalization system includes:
a transformer;
a battery cluster including a plurality of battery cells; the plurality of battery cells are positioned on one side of the transformer; and
an auxiliary power supply provided on the other side of the transformer;
the active equalization method includes:
obtaining a battery cell set to be balanced in the battery cluster;
determining whether a battery cell to be balanced in the battery cell set to be balanced contains a charging battery cell;
in response to that the charging battery cell is contained, adding one charging battery cell to a preset starting queue;
determining whether the battery cell to be balanced in the battery cell set to be balanced contains a discharging battery cell;
in response to that the discharging battery cell is contained, adding one discharging battery cell to the starting queue;
determining whether a number of discharging battery cells of the starting queue reaches a preset value;
in response to that the number of the discharging battery cells of the starting queue reaches the value, determining whether the starting queue is a non-empty queue; the non-empty queue indicates that the starting queue includes at least one of the charging battery cells, or at least one of the discharging battery cells; and
in response to that the starting queue is the non-empty queue, balancing the charging battery cell and the discharging battery cell in the starting queue.

The active equalization method according to the embodiment of the present application has at least the following beneficial effects: first, obtaining a battery cell set to be balanced in a battery cluster; second, determining whether the battery cell to be balanced in the battery cell set to be balanced contains a charging battery cell or not; third, when the charging battery cell is contained, adding a charging battery cell to a preset starting queue; fourth, determining whether the battery cell to be balanced in the battery cell set to be balanced contains a discharging battery cell or not; fifth, adding the discharging battery cell to an starting queue when the discharging battery cell is contained; sixth, determining whether the number of discharging battery cells of the starting queue reaches a preset value; seventh, when the number of discharging battery cells of the starting queue reaches the value, determining whether the starting queue is a non-empty queue; the non-empty queue means that the starting queue includes at least one charging battery cell, or at least one discharging battery cell; and eighth, when the starting queue is a non-empty queue, balancing the charging battery cells and the discharging battery cells in the starting queue. According to the active equalization method, when the battery cells in the battery cluster need to be equalized, the quantity of the battery cells to be equalized is obtained, and the charging battery cells and the discharging battery cells which are equalized simultaneously are designated in a value setting mode. The value setting can enable the power required by charging and the power required by discharging in the whole equalization loop to be matched with each other, so that the situation that the phase difference between the charging power and the discharging power is too large, the voltage in the loop is caused to be greatly fluctuated, the fluctuation of the voltage of the auxiliary power supply in the loop is avoided, and the stability of the battery in the equalization process is improved. Therefore, the active equalization method can improve the stability of battery equalization by avoiding the voltage fluctuation of the auxiliary power supply.

According to some embodiments of the first aspect of the present application, the active equalization method further including:
in response to that the battery cell to be balanced does not contain the charging battery cell, jumping to the determining whether the number of the discharging battery cells of the starting queue reaches the preset value.

According to some embodiments of the first aspect of the present application, the active equalization method further including:
in response to that the battery cell to be balanced does not contain the discharging battery cell, jumping to the determining whether the starting queue is the non-empty queue.

According to some embodiments of the first aspect of the present application, the active equalization method further including:
in response to that the number of the discharging battery cells in the starting queue does not reach the value in a set time, balancing the charging battery cell and all the discharging battery cell in the current starting queue.

According to some embodiments of the first aspect of the present application, the value is calculated by:
calculating to obtain a first balanced power of the charging battery cell in a balancing process through a first battery cell voltage, balanced current and balanced efficiency in response to that the charging battery cell is balanced; the balanced current represents current generated by a balanced loop in response to that balancing is performed; the balanced loop is composed of the battery cell to be balanced, the transformer and the auxiliary power supply, and the balanced efficiency is obtained through loss calculation of the balanced loop;
calculating to obtain a second balanced power of the discharging battery cell in the balancing process through a second battery cell voltage, the balanced current and the balanced efficiency in response to that the discharging battery cell is balanced; the first battery cell voltage is equal to the second battery cell voltage; and
setting the value through the first balanced power and the second balanced power.

According to some embodiments of the first aspect of the present application, the setting the value through the first balanced power and the second balanced power includes:
calculating a ratio of the first balanced power and the second balanced power, and setting the value according to the ratio and a power consumption condition of a control switch in the balanced loop.

According to some embodiments of the first aspect of the present application, the active equalization method further including:
ending the active equalization method in response to that the starting queue is not the non-empty queue.

An active equalization system according to an embodiment of the second aspect of the present application, including:
a transformer;
a battery cluster including a plurality of battery cells;
a channel selection module provided on one side of the transformer; the channel selection module is configured for connecting the battery cells to be balanced in the plurality of battery cells to the transformer;
an auxiliary power supply provided on the other side of the transformer;
a first switch module provided between the channel selection module and one side of the transformer;
a second switch module provided on the other side of the transformer, such as, provided between the other side of the transformer and the auxiliary power supply; and
a control module configured for performing the active equalization method according to the embodiment of the first aspect.

An active equalization system according to an embodiment of the third aspect of the present application, including:
at least one memory;
at least one processor; and
at least one program;
the program is stored in the memory, and the at least one of the program is executed by the processor to perform the active equalization method according to the embodiment of the first aspect.

A computer readable storage medium according to an embodiment of the fourth aspect of the present application, storing instructions executed by a computer; the instructions executed by the computer are configured for causing the computer to perform the active equalization method according to the embodiment of the first aspect.

Additional aspects and advantages of the present application will be set forth in part in the description which follows, and the part will be obvious from the description, or may be learned by practice of the present application.

### BRIEF DESCRIPTION OF THE DRAWINGS

The present application is further described with reference to the accompanying drawings and examples, in which:

FIG. 1 is a flowchart of an active equalization method according to an embodiment of the present application;

FIG. 2 is a schematic diagram of a connection of an active equalization system according to an embodiment of the present application;

FIG. 3 is a flowchart of the active equalization method according to another embodiment of the present application; and

FIG. 4 is a schematic structural diagram of the active equalization system according to another embodiment of the present application.

### DETAILED DESCRIPTION OF EMBODIMENTS

Embodiments of the present application are described in detail below, examples of which are illustrated in the accompanying drawings; like or similar reference numerals refer to like or similar elements or elements having like or similar functions throughout. The embodiments described below by referring to the accompanying drawings are exemplary only for the purpose of explaining the present application and are not to be construed as limiting the present application.

It should be noted that although functional block diagrams are depicted as block diagrams, and logical sequences are shown in the flowchart, in some cases, the steps shown or described may be performed in a different order than the block diagrams in the system. The terms and the like in the description and in the claims, and in the above-described drawings, are configured for distinguishing between similar elements and not necessarily for describing a particular sequential or chronological order.

In the description of the present application, the meaning of several is one or more, and the meaning of plurality is two or more; greater than, less than, exceeding, etc. are understood to exclude the present number, and the meaning of above, below, within, etc. are understood to include the present number. The description of the first and second is for the purpose of distinguishing between technical features only and should not be construed as indicating or implying relative importance or implicitly indicating the number of technical features indicated or implicitly indicating the precedence of the technical features indicated.

In the description of the present application, unless explicitly defined otherwise, terms such as arrangement, installation, connection, etc. should be construed broadly and the specific meaning of the terms in the present application can be reasonably determined by a person skilled in the art in combination with the specific contents of the technical solution.

In the description of the present application, a description with reference to the terms “one embodiment”, “some embodiments”, “illustrative embodiments”, “examples”, “specific examples”, or “some examples” etc., means that a particular feature, structure, material, or characteristic described in connection with the embodiment or example is included in at least one embodiment or example of the present application. In this specification, schematic representations of the above terms do not necessarily refer to the same embodiments or examples. Furthermore, the particular features, structures, materials, or characteristics described may be combined in any suitable manner in any one or more embodiments or examples.

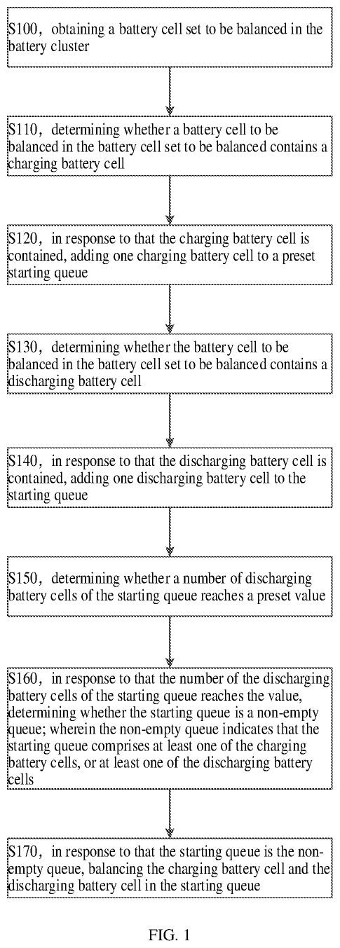

Next, an active equalization method according to an embodiment of the present application is described with reference to FIGS. 1 to 4.

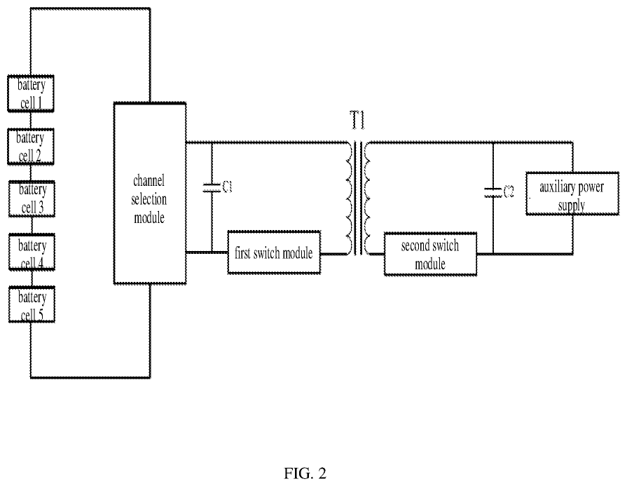

As can be appreciated, as shown in FIGS. 1 and 2, an active equalization method is provided, applied to an active equalization system, the active equalization system includes:
a transformer;
a battery cluster including a plurality of battery cells; the battery cells are positioned on one side of the transformer;
an auxiliary power supply provided on the other side of the transformer;
the active equalization method includes the following steps:
step S100, obtaining a battery cell set to be balanced in the battery cluster;
step S110, determining whether a battery cell to be balanced in the battery cell set to be balanced contains a charging battery cell;
step S120, in response to that the charging battery cell is contained, adding one charging battery cell to a preset starting queue;
step S130, determining whether the battery cell to be balanced in the battery cell set to be balanced contains a discharging battery cell;
step S140, in response to that the discharging battery cell is contained, adding one discharging battery cell to the starting queue;
step S150, determining whether a number of discharging battery cells of the starting queue reaches a preset value;
step S160, in response to that the number of the discharging battery cells of the starting queue reaches the value, determining whether the starting queue is a non-empty queue; the non-empty queue indicates that the starting queue includes at least one of the charging battery cells, or at least one of the discharging battery cells;
step S170, in response to that the starting queue is the non-empty queue, balancing the charging battery cell and the discharging battery cell in the starting queue.

First, obtaining a battery cell set to be balanced in a battery cluster; second, determining whether the battery cell to be balanced in the battery cell set to be balanced contain a charging battery cell or not; third, when the charging battery cell is contained, adding a charging battery cell to a preset starting queue; fourth, determining whether the battery cell to be balanced in the battery cell set to be balanced contains discharging battery cell or not; fifth, adding a discharging battery cell to an starting queue when the discharging battery cell is contained; sixth, determining whether the number of discharging battery cells of the starting queue reaches a preset value; seventh, when the number of discharging battery cells of the starting queue reaches the value, determining whether the starting queue is a non-empty queue; the non-empty queue means that the starting queue includes at least one charging battery cell, or at least one discharging battery cell; and eighth, when the starting queue is a non-empty queue, balancing the charging battery cells and the discharging battery cells in the starting queue. According to the active equalization method, when the battery cells in the battery cluster need to be equalized, the quantity of the battery cells to be equalized is obtained, and the charging battery cells and the discharging battery cells which are equalized simultaneously are designated in a value setting mode. The value setting can enable the power required by charging and the power required by discharging in the whole equalization loop to be matched with each other, so that the situation that the phase difference between the charging power and the discharging power is too large, and the voltage in the loop is caused to be greatly fluctuated, thereby avoiding the fluctuation of the voltage of the auxiliary power supply in the loop, and improving the stability of the battery in the equalization process. Therefore, the active equalization method can improve the stability of battery equalization by avoiding the voltage fluctuation of the auxiliary power supply.

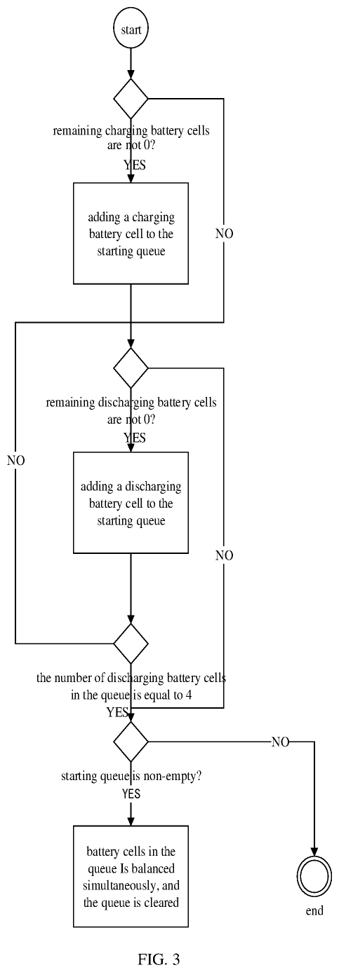

It will be appreciated that as shown in FIG. 3, the active equalization method further includes:
when the battery cell to be balanced does not contain the charging battery cell, jumping to the step:
determining whether the number of discharging battery cells of the starting queue reaches a preset value.

It will be appreciated that as shown in FIG. 3, the active equalization method further includes:
when the battery cell to be balanced does not contain a discharging battery cell, jumping to the step:
determining whether the starting queue is a non-empty queue.

It will be appreciated that as shown in FIG. 3, the active equalization method further includes:
when the number of the discharging battery cells in the starting queue does not reach the value in the set time, balancing the charging battery cells and all the discharging battery cells in the current starting queue.

It will be appreciated that as shown in FIG. 3, the active equalization method further includes:
when the number of the discharging battery cells of the starting queue does not reach the value in the set time, determining whether the battery cells to be balanced have charging battery cells or not;
when the battery cells to be balanced are provided with the charging battery cells, adding all the charging battery cells into the starting queue, and balancing the charging battery cells and all the discharging battery cells in the current starting queue.

It will be appreciated that as shown in FIG. 3, the values are calculated by the following steps:
calculating to obtain a first balanced power of the charging battery cell in the balancing process through a first battery cell voltage, balanced current and balanced efficiency when the charging battery cell is balanced; the balanced current represents the current generated by the balanced loop when balancing; the balanced loop consists of a battery cell to be balanced and a transformer; and the balanced efficiency is obtained by measuring and calculating the loss of the balanced loop;
calculating to obtain a second balanced power of the discharging battery cell in the balancing process through second battery cell voltage, balanced current and balanced efficiency when the discharging battery cell is balanced; the first battery cell voltage is equal to the second battery cell voltage;
and setting a value through the first balanced power and the second balanced power.

It will be appreciated that, as shown in FIG. 3, the setting the value by the first balanced power and the second balanced power includes:
calculating to obtain the ratio of the first balanced power to the second balanced power, and setting the value according to the ratio and the power consumption condition of the control switch in the balanced loop.

It should be noted that this value may be 4. The exemplary setting process is as follows:

Referring to FIG. 2, in conjunction with the experiment, an exemplary embodiment is provided:
the active equalization system needs to exchange energy by taking a 24v auxiliary power supply as an energy transmission channel, and the power ratio required by charge equalization and discharge equalization is determined based on the energy conversion efficiency of the two ends of the transformer Tl by the following formula:

Balanced power required for charging=(battery cell voltage*equalization current)/55%;

Balanced power required for discharging=(battery cell voltage*equalization current)*55%;

Therefore, the ratio of the balanced power required for charging to the balanced power required for discharging is 1:3.3; since the external switching voltage provides a power much greater than the external consumed power, this ratio can be increased to 1:4. 55% is equalization efficiency, the value sources are loss at two ends of the transformer and a series of circuit loss such as MOS tube, fuse, etc., and the value is actual measurement value of the circuit. The battery cell voltage can be understood as the voltage of the battery cell to be balanced, and the balanced current is provided by an auxiliary power supply and constant current power supply is ensured.

It should be noted that the calculation of the balanced power, the battery cell voltage and the balanced current are related coefficients, and the balanced efficiency required by charging and the balanced efficiency required by discharging are kept in the same proportion. With reference to FIG. 3, the active equalization method in the embodiment of the present application is as follows:

Step 1, determining whether the charging battery cells to be balanced exist or not based on the calculated proportion values; if so, adding the charging battery cells to be balanced into an equalization queue; and if not, determining whether the discharging battery cells to be balanced exist or not.

Step 2, if the discharging battery cells to be balanced exist, adding the discharging battery cells into the starting queue.

Step 3, determining whether the number of the discharging battery cells in the starting queue is equal to four; if so, simultaneously starting all the battery cells in the starting queue for balancing; and if the number of the discharging battery cells in the starting queue is less than four, simultaneously starting the residual battery cells with the balanced battery cells. Of course, if the number of the discharging battery cells in the starting queue is less than four, it is further possible to continuously determine whether there are any more charging battery cells to be balanced, and add all the charging battery cells to be balanced into the starting queue and simultaneously open.

Step 4, continuing to perform the steps 2-4 after starting a round of equalization, and ending if the quantity of the balanced charging battery cells and the balanced discharging battery cells is 0.

The method aims at starting all the battery cells needing to be balanced in groups, and effectively improves the stability of the 24 v auxiliary power supply.

In the existing method, all the battery cells are required to be started together for balancing, and the problems of logic simultaneous starting and difference in starting time on the circuit exist due to communication delay and errors of capacitance and resistance of the circuit. Therefore, when the balanced charging power on the 24 v auxiliary power supply is far greater than the balanced discharging power, the power provided by the switching power supply is insufficient, so that the 24 v auxiliary power supply voltage is reduced, and the constant current power supply of the balanced circuit 2A is maintained; if the balanced discharging power on the 24 v auxiliary power supply is far greater than the balanced charging power, the 24 v auxiliary power supply voltage is increased to maintain the constant current supply of the balanced circuit 2A.

By adopting the active equalization method, the balanced charging power and the balanced discharging power on the 24 v auxiliary power supply can be kept in a smaller range when the equalization is started in a grouping mode, and the voltage on the 24 v auxiliary power supply cannot be interfered.

For example, it is assumed that the power provided on the 24V auxiliary power supply is 100 w, the load provided is 30 w, the cell voltage is 3.3V, and the balanced current is 2 A. At this time, the charging balance of one charging battery cell is started, the balanced power required for charging is 12 w according to the calculation, namely 12w is required to be consumed, the residual power on 24 v auxiliary power supply is 88 w at this time; then 4 paths of discharging battery cells are started for balancing, the discharging power of the discharging balance is 14.52 w according to the calculation, and at this time, the 12 w power and the charging balance are offset, and the residual power is 2.52 w. Finally, 2.52 w of power is distributed to the load, so that 27.48 w of the load remains, and the whole process exceeds the power provided by the auxiliary power supply and the load consumption capacity, so that the voltage fluctuation of the auxiliary power supply is not caused.

It will be appreciated that as shown in FIG. 3, the active equalization method further includes:
when the starting queue is not a non-empty queue, ending the active equalization method.

It will be appreciated that as shown in FIG. 2, an active equalization system is also provided, and the active equalization system includes:
a transformer;
a battery cluster including a plurality of battery cells;
a channel selection module provided on one side of the transformer and configured for connecting the battery cells to be balanced in the battery cells to the transformer;
an auxiliary power supply provided on the other side of the transformer;
a first switch module provided between the channel selection module and one side of the transformer;
a second switch module provided on the other side of the transformer and the auxiliary power supply;
a control module configured for performing the active equalization method in this embodiment.

It should be noted that, the first switch module and the second switch module may be MOS switch tubes, which are configured for controlling the on-off of the loop, and the channel selection module may be controlled by the control module to select the battery cells to be balanced, and incorporate the battery cells to be balanced into one side of the transformer.

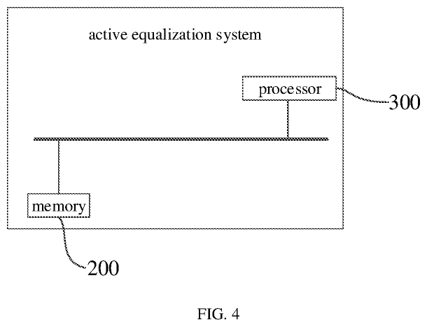

An active equalization system according to an embodiment of the present application is described below with reference to FIG. 4.

It will be appreciated that as shown in FIG. 4, the active equalization system includes:
at least one memory 200;
at least one processor 300;
at least one program or program product;
the program is stored in the memory 200 and the processor 300 executes at least one program to implement the active equalization method described above. FIG. 4 illustrates a processor 300 as an example.

The processor 300 and the memory 200 may be connected by a bus or other means. FIG. 4 is an example of a connection by a bus.

The memory 200 is used as a non-transitory computer readable storage medium for storing non-transitory software programs, non-transitory computer executable programs, and signals, such as program instructions/signals corresponding to the active equalization system in the embodiments of the present application. The processor 300 performs various functional applications and data processing by running non-transitory software programs, instructions, and signals stored in the memory 200, i.e., implementing the active equalization method of the above-described method embodiments.

Memory 200 may include a program storage area and a data storage area; the program storage area can store an operating system and an application program required for at least one function; the data storage area may store related data of the active equalization method described above, etc. In addition, memory 200 may include high-speed random access memory, and may also include non-transitory memory, such as at least one magnetic disk storage device, flash memory device, or other non-transitory solid state storage device. In some embodiments, memory 200 may optionally include memory located remotely from processor 300, which may be connected to the active equalization system via a network. Examples of such networks include, but are not limited to, the internet of things, software defined networks, sensor networks, the internet, intranets, local area networks, mobile communication networks, and combinations thereof.

One or more signals are stored in memory 200. When the signals are executed by one or more processors 300, the active equalization method of any of the method embodiments described above is performed. For example, the method of FIG. 1 or 3 described above is performed.

A computer-readable storage medium according to an embodiment of the present application is described below with reference to FIG. 4.

As shown in FIG. 4, the computer-readable storage medium stores computer-executable instructions that are executed by one or more processors 300, for example, by one of the processors 300 in FIG. 4, which may cause the one or more processors 300 to perform the active equalization method in the method embodiment described above. For example, the method of FIG. 1 or 3 described above is performed.

The system embodiments described above are merely illustrative, in which units illustrated as separate elements may or may not be physically separate, and elements shown as units may or may not be physical units, and it may be located in one place, or may be distributed over a plurality of network units. Some or all of the units may be selected according to actual needs to achieve the purpose of the solution of this embodiment.

From the description of the embodiments above, those skilled in the art will appreciate that all or some of the steps, systems, and methods disclosed above may be implemented as software, firmware, hardware, and suitable combinations thereof. Some or all of the physical components may be implemented as software executed by a processor, such as a central processing unit, digital signal processor, or microprocessor, or as hardware, or as an integrated circuit, such as an application specific integrated circuit. Such software may be distributed on computer readable media, which may include computer storage media and communication media. The term computer storage media includes both volatile and nonvolatile, removable and non-removable media implemented in any method or technology for storage of information, as known to those skilled in the art. Computer storage media includes, but is not limited to, RAM, ROM, EEPROM, flash memory or other memory technology, CD-ROM, digital versatile disks or other optical disk storage, magnetic cassettes, magnetic tape, magnetic disk storage or other magnetic storage devices, or any other medium which can be used to store the desired information and which can be accessed by a computer. Furthermore, as is well known to those skilled in the art, communication media typically embodies computer readable signals, data structures, program modules or other data in a modulated data signal such as a carrier wave or other transport mechanism and may include any information delivery media.

The embodiments of the present application have been described in detail above with reference to the accompanying drawings, but the present application is not limited to the above embodiments, and various changes can be made within the knowledge of those skilled in the art without departing from the spirit of the present application. Furthermore, embodiments of the present application and features of the embodiments may be combined with each other without conflict.

What is claimed is:

1. An active equalization method, applicable to an active equalization system,
wherein the active equalization system comprises:
a transformer;
a battery cluster comprising a plurality of battery cells, wherein the plurality of battery cells are positioned on a first side of the transformer; and
an auxiliary power supply provided on a second side of the transformer;
wherein the active equalization method comprises:
obtaining a battery cell set to be balanced in the battery cluster;
determining whether a battery cell to be balanced in the battery cell set comprises a charging battery cell;
in response to that the charging battery cell is contained, adding one charging battery cell to a preset starting queue;
determining whether the battery cell to be balanced in the battery cell set to be balanced contains a discharging battery cell;
in response to that the discharging battery cell is contained, adding one discharging battery cell to the starting queue;
determining whether a number of discharging battery cells of the starting queue reaches a preset value;
in response to that the number of the discharging battery cells of the starting queue reaches the preset value, determining whether the starting queue is a non-empty queue, wherein the non-empty queue indicates that the starting queue comprises at least one of the charging battery cells, or at least one of the discharging battery cells; and
in response to that the starting queue is the non-empty queue, balancing the charging battery cell and the discharging battery cell in the starting queue.

2. The active equalization method of claim 1, further comprising:
in response to that the battery cell to be balanced does not contain the charging battery cell, jumping to the determining whether the number of the discharging battery cells of the starting queue reaches the preset value.

3. The active equalization method of claim 1, further comprising:
in response to that the battery cell to be balanced does not contain the discharging battery cell, jumping to the determining whether the starting queue is the non-empty queue.

4. The active equalization method of claim 1, further comprising:
in response to that the number of the discharging battery cells in the starting queue does not reach the preset value in a set time, balancing the charging battery cell and all the discharging battery cell in the current starting queue.

5. The active equalization method of claim 1, wherein the preset value is calculated by:
calculating to obtain a first balanced power of the charging battery cell in a balancing process through a first battery cell voltage, balanced current and balanced efficiency in response to that the charging battery cell is balanced; wherein the balanced current represents current generated by a balanced loop in response to that balancing is performed; the balanced loop is composed of the battery cell to be balanced, the transformer and the auxiliary power supply, and the balanced efficiency is obtained through loss calculation of the balanced loop;
calculating to obtain a second balanced power of the discharging battery cell in the balancing process through a second battery cell voltage, the balanced current and the balanced efficiency in response to that the discharging battery cell is balanced; wherein the first battery cell voltage is equal to the second battery cell voltage; and
setting the preset value through the first balanced power and the second balanced power.

6. The active equalization method of claim 5, wherein the setting the preset value through the first balanced power and the second balanced power comprises:
calculating a ratio of the first balanced power and the second balanced power, and setting the preset value according to the ratio and a power consumption condition of a control switch in the balanced loop.

7. The active equalization method of claim 1, further comprising:
ending the active equalization method in response to that the starting queue is not the non-empty queue.

8. An active equalization system comprising:
a transformer;
a battery cluster comprising a plurality of battery cells;
a channel selector provided on a first side of the transformer, wherein the channel selector is configured for connecting at least one cell to be balanced in the plurality of battery cells to the transformer;
an auxiliary power supply provided on a second side of the transformer;
a first switch provided between the channel selector and the first side of the transformer;
a second switch provided between the second side of the transformer and the auxiliary power supply; and
a controller configured for performing an active equalization method comprising:
obtaining a battery cell set to be balanced in the battery cluster;
determining whether a battery cell to be balanced in the battery cell set comprises a charging battery cell;
in response to that the charging battery cell is contained, adding one charging battery cell to a preset starting queue;
determining whether the battery cell to be balanced in the battery cell set to be balanced contains a discharging battery cell;
in response to that the discharging battery cell is contained, adding one discharging battery cell to the starting queue;
determining whether a number of discharging battery cells of the starting queue reaches a preset value;
in response to that the number of the discharging battery cells of the starting queue reaches the preset value, determining whether the starting queue is a non-empty queue; wherein the non-empty queue indicates that the starting queue comprises at least one of the charging battery cells, or at least one of the discharging battery cells; and
in response to that the starting queue is the non-empty queue, balancing the charging battery cell and the discharging battery cell in the starting queue.

9. The active equalization system of claim 8, wherein the active equalization method further comprises:
in response to that the battery cell to be balanced does not contain the charging battery cell, jumping to the determining whether the number of the discharging battery cells of the starting queue reaches the preset value.

10. The active equalization system of claim 8, wherein the active equalization method further comprises:
in response to that the battery cell to be balanced does not contain the discharging battery cell, jumping to the determining whether the starting queue is the non-empty queue.

11. The active equalization system of claim 8, wherein the active equalization method further comprises:
in response to that the number of the discharging battery cells in the starting queue does not reach the preset value in a set time, balancing the charging battery cell and all the discharging battery cell in the current starting queue.

12. The active equalization system of claim 8, wherein the preset value is calculated by:
calculating to obtain a first balanced power of the charging battery cell in a balancing process through a first battery cell voltage, balanced current and balanced efficiency in response to that the charging battery cell is balanced; wherein the balanced current represents current generated by a balanced loop in response to that balancing is performed; the balanced loop is composed of the battery cell to be balanced, the transformer and the auxiliary power supply, and the balanced efficiency is obtained through loss calculation of the balanced loop;
calculating to obtain a second balanced power of the discharging battery cell in the balancing process through a second battery cell voltage, the balanced current and the balanced efficiency in response to that the discharging battery cell is balanced; wherein the first battery cell voltage is equal to the second battery cell voltage; and
setting the preset value through the first balanced power and the second balanced power.

13. The active equalization system of claim 12, wherein the setting the preset value through the first balanced power and the second balanced power comprises:
calculating a ratio of the first balanced power and the second balanced power, and setting the preset value according to the ratio and a power consumption condition of a control switch in the balanced loop.

14. The active equalization system of claim 8, wherein the active equalization method further comprises:
ending the active equalization method in response to that the starting queue is not the non-empty queue.

15. An active equalization system comprising:
at least one memory;
at least one processor; and
at least one program,
wherein the program is stored in the memory, and the at least one of the program is executable by the at least one processor to perform the active equalization method of claim 1.

16. A computer-readable storage medium, storing instructions executable by a computer, wherein the instructions are configured to be executable by the computer for causing the computer to perform the active equalization method of claim 1.
